(19) United States
(12) Patent Application Publication
(10) Pub. No.: US 2020/0261915 A1
(43) Pub. Date: Aug. 20, 2020

(54) Device for Storing and Viewing Preserved DNA

(71) Applicant: Dmitri Dozortsev, Houston, TX (US)

(72) Inventor: Dmitri Dozortsev, Houston, TX (US)

(21) Appl. No.: 16/519,091

(22) Filed: Jul. 23, 2019

Related U.S. Application Data
(60) Provisional application No. 62/806,945, filed on Feb. 18, 2019.

(51) Int. Cl. B01L 9/00; G02B 21/26; G02B 21/34

(52) U.S. Cl. CPC B01L 9/52; G02B 21/26; G02B 21/34; B01L 2300/12; B01L 2300/0809; B01L 2300/08; B01L 2300/0851

(57) ABSTRACT

Provided herein are devices or viewers for storing and/or viewing a preserved DNA specimen. The device has a top viewing section and a bottom base section and the viewer has a single body with an upper viewing portion interfaced with a lower base portion. The device and the viewer each have a slide receptacle formed therein to receive a slide containing the DNA specimen and a viewing scope with an eyepiece and a magnifying lens disposed therein in optical alignment with the slide receptacle and slide.

### CROSS-REFERENCE TO RELATED APPLICATION

This non-provisional application claims benefit of priority under 35 U.S.C. § 119(e) of provisional application U.S. Ser. No. 62/806,945, filed Feb. 18, 2019, the entirety of which is hereby incorporated by reference.

### BACKGROUND OF THE INVENTION

### Field of the Invention

The invention relates to the field of human infertility. More specifically, the present invention is directed to a device for viewing a preserved DNA specimen of a pre-implantation embryo created by in vitro fertilization as an alternative to discarding the embryo.

### Description of the Related Art

In vitro fertilization (IVF) is a process of forming a zygote by combining an egg with a sperm outside the body. In vitro fertilization is a popular choice for couples wishing to overcome infertility or otherwise unable to conceive naturally. The process of in vitro fertilization involves monitoring and stimulating a woman's ovulatory process, removing ova from the ovaries and allowing a sperm to fertilize them in a test tube or petri dish.

The success of in vitro fertilization to produce viable embryos is apparent from studies showing that this procedure has substantially contributed to twins, triplets and higher-order infants born in the United States. In many cases the number of embryos created during in vitro fertilization exceeds the number of embryos that a recipient desires to carry to term. At the same time social and psychological factors make donating unwanted embryos or discarding them unacceptable or difficult. Currently, other than expensive cryopreservation of embryos, there are no options available for preserving the DNA from a fertilized egg.

Thus, there is a deficiency in the art for devices that allow storage and viewing of the DNA of preimplantation human embryos. The present invention fulfills this longstanding need and desire in the art.

### SUMMARY OF THE INVENTION

The present invention is directed to a device for storing and viewing a preserved DNA specimen. The device has a top viewing section with a top surface and a bottom surface and at least one opening formed through the top surface to the bottom surface and a bottom base section with a top base surface and a bottom base surface where the top base surface is removably connectable with the bottom surface of the top viewing section. At least one slide receptacle is formed on the top base surface and is sized to receive therein a slide on which the DNA specimen is preserved. At least one viewing scope comprising an eyepiece at a proximal end thereof and a magnifying lens at a distal end thereof is disposed within the at least one opening through the top viewing section in optical alignment with the opening formed through the slide receptacle. The device comprises means for connecting the top viewing section to the bottom base section.

The present invention is directed to a related device for storing and viewing a preserved DNA specimen that further comprises a slot formed on an outer surface of the bottom base section in connection with the slide receptacle.

The present invention is directed to another related device for storing and viewing a preserved DNA specimen that further comprises at least one opening formed through the bottom base surface of the bottom base section to the slide receptacle and in optical alignment with the viewing scope.

The present invention is directed to yet another related device for storing and viewing a preserved DNA specimen that further comprises means for securing the slide to the slide receptacle.

The present invention also is directed to a viewer for viewing a preserved DNA specimen. The viewer comprises an optically transparent and substantially solid body that has an upper viewing portion interfaced with a lower base portion, an opening formed on the upper viewing portion through to the interface with the lower base portion, a slot formed on an outer surface of the body at the interface, and a slide receptacle formed from the slot at the interface and with dimensions sufficient to receive through the slot a slide on which the DNA specimen is preserved. The viewer also comprises a viewing scope that has an eyepiece at a proximal end thereof and a magnifying lens at a distal end thereof disposed within the opening in the upper viewing portion and in optical alignment with the slide receptacle.

The present invention is directed to a related viewer that further comprises an opening formed on the lower base portion through to the slide receptacle and in optical alignment with the opening through the upper viewing portion.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIG. 1 is a front view of a viewer for viewing a DNA specimen comprising a fully transparent rectangular cuboid box, a viewing scope and a slide receptacle.

FIGS. 2A-2C shows another device for viewing a DNA specimen. FIG. 2A is a front view of the device comprising a transparent top portion, a bottom portion, a viewing scope and a slide receptacle. FIG. 2B is a view of the bottom portion of the device showing the slide receptacle. FIG. 2C is an exploded view of the device showing the top portion, the bottom portion, the viewing scope, the slide receptacle and a plurality of magnets for securing the top portion to the bottom portion.

FIGS. 3A-3B show yet another device for viewing a DNA specimen. FIG. 3A is a front view of the device comprising a fully transparent rectangular cuboid box with a transparent base, a pair of viewing scope and a slide receptacle. FIG. 3B is an open view of the device with the rectangular cuboid box separated from the transparent base showing a specimen slide secured to the slide receptacle and a plurality of magnets for securing the rectangular cuboid box to the base.

### DETAILED DESCRIPTION OF THE INVENTION

For convenience, before further description of the present invention, certain terms employed in the specification, examples and appended claims are collected herein. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”. “Including” and “including but not limited to” are used interchangeably.

As used herein, the term “proximal” refers to nearer or nearest to a user's and “distal” refers to farther or farthest from the user's eye.

In one embodiment of the present invention, there is provided a device for storing and viewing a preserved DNA specimen, comprising a top viewing section with a top surface and a bottom surface and at least one opening formed through the top surface to the bottom surface; a bottom base section with a top base surface and a bottom base surface, the top base surface removably connectable with the bottom surface of the top viewing section; at least one slide receptacle formed on the top base surface and sized to receive therein a slide on which the DNA specimen is preserved; at least one viewing scope comprising an eyepiece at a proximal end thereof and a magnifying lens at a distal end thereof, said viewing scope disposed within the at least one opening through the top viewing section in optical alignment with the opening formed through the slide receptacle; and means for connecting the top viewing section to the bottom base section.

Further to this embodiment, the device comprises a slot formed on an outer surface of the bottom base section in connection with the slide receptacle. In another further embodiment the device comprises at least one opening formed through the bottom base surface of the bottom base section to the slide receptacle and in optical alignment with the viewing scope. In yet another further embodiment the device comprises means for securing the slide to the slide receptacle.

In all embodiments, the slide receptacle may be sized with dimensions larger than dimensions of the slide such that the slide is movable therewithin to optically align the DNA specimen with the viewing scope. Also in all embodiments, the means for connecting the top viewing section to the bottom base section may be a plurality of magnets disposed on the bottom surface of the top viewing section and on the top base surface of the bottom base section. In an aspect of this embodiment, the bottom surface of the top viewing section and the top base surface of the bottom base section each may further comprise a plurality of cavities formed thereon, where the bottom surface cavities are in alignment with the top base surface cavities and the plurality of magnets is disposed within the cavities.

In all embodiments, the top viewing section may be substantially transparent. Also, the top viewing section may be substantially cuboid in shape or substantially pyramidal in shape. In addition, the bottom base section of the viewer may be substantially cuboid. In addition the top viewing section and the bottom base section may be independently made from at least one material selected from the group consisting of a plastic, a plastic composite, a metal, and a metal composite. Particularly, the plastic may be selected from the group consisting of polyethylene terephthalate, polyethylene, polyvinyl chloride, polypropylene, polystyrene, polycarbonate, poly(methyl methacrylate) and fiberglass. Furthermore, the preserved DNA specimen may be a preimplantation embryonic DNA specimen or a eukaryotic cellular DNA specimen.

In another embodiment of the present invention, there is provided a viewer for viewing a preserved DNA specimen comprising an optically transparent and substantially solid body comprising an upper viewing portion interfaced with a lower base portion; an opening formed on the upper viewing portion through to the interface with the lower base portion; a slot formed on an outer surface of the body at the interface; and a slide receptacle formed from the slot at the interface and with dimensions sufficient to receive through the slot a slide on which the DNA specimen is preserved; and a viewing scope comprising an eyepiece at a proximal end thereof and a magnifying lens at a distal end thereof disposed within the opening in the upper viewing portion and in optical alignment with the slide receptacle. Further to this embodiment the viewer comprises an opening formed on the lower base portion through to the slide receptacle and in optical alignment with the opening through the upper viewing portion.

In both embodiments, the dimensions of the slide receptacle may be larger than dimensions of the slide such that the slide is movable therewithin to optically align the DNA specimen thereon with the viewing scope. Also in both embodiments the body may be substantially cuboid or substantially pyramidal in shape. In addition the body may be made from a plastic material or a plastic composite material. Particularly, the plastic material may be selected from the group consisting of polyethylene terephthalate, polyethylene, polyvinyl chloride, polypropylene, polystyrene, polycarbonate, poly(methyl methacrylate) and fiberglass. Furthermore the preserved DNA specimen may be a preimplantation embryonic DNA specimen or a eukaryotic cellular DNA specimen.

Described herein are devices and viewers for storing and/or viewing a preserved DNA specimen, for example, a preimplantation embryonic DNA specimen or a eukaryotic cellular DNA specimen preserved on a slide such as a microscope slide. The preserved DNA may be from a mammal, particularly, a human. The preserved DNA be a naturally fertilized embryo, or an embryo obtained after in vitro fertilization.

Generally, the device or the viewer may comprise separate top and bottom sections, for example, a top viewing section and a bottom base section, at least one viewing scope or magnifying instrument disposed in an opening through the top section, at least one slide receptacle formed in the bottom section so that a slide positioned therein and the preserved DNA fixed thereon are in optical alignment with the viewing scope and means for connecting the top and bottom sections. Optionally, the bottom section may have an opening through to the slide receptacle in optical alignment with the opening in the top viewing scope. Also, optionally, a slot may be formed in the bottom section enabling access to the slide receptacle without separating the top and bottom sections. The top and bottom sections may be connected by magnets disposed within cavities formed in alignment in the bottom surface of the top section and the top surface of the bottom section. Other means of removably connecting the top and bottom sections may be used, for example, snaps or similar snapping means.

Alternatively, the device or the viewer may comprise a single solid body with a top portion having an opening and a bottom portion, for example, a top viewing portion interfaced with a bottom base portion, a slot into the body and a slide receptacle formed in the bottom portion and accessed through the slot. The viewing scope is disposed in an opening through the top portion in optical alignment with the slide receptacle as with the two sections device. The viewer may optionally comprise an opening in the bottom portion through to the slide receptacle at the interface in optical alignment with the opening in the top portion.

The device and viewer are substantially solid and may have a substantially cuboidal, rectangular cuboidal, pyramidal, or cylindrical shape. The device or viewer comprising the two connected sections may comprise a combination of these shapes, for example, a cupoidal or rectangular cupoidal bottom section and a substantially pyrimidal top section. The device or viewer may be optically transparent or may have an optically transparent top section or top portion and a non-transparent bottom section or bottom portion. A device or viewer with a non-transparent bottom section or portion comprises the opening through the bottom to enable ambient light or light from a dedicated light source to reach the slide and viewing scope.

Transparent and non-transparent materials include, but are not limited to, a plastic, a metal, a metal alloy, a plastic composite, a metal composite, or a combination of these materials. Examples of plastics include but are not limited to poly(methyl methacrylate), polyethylene terephthalate, polyethylene, polyvinyl chloride, polypropylene, polystyrene, polycarbonate and fiberglass, or a combination of these materials. The eye piece and the magnifying lens comprising the viewing scope are made of an optically clear glass or an optically clear plastic including, but not limited to poly(methyl methacrylate), polyethylene terephthalate, polyethylene, polyvinyl chloride, polypropylene, polystyrene, polycarbonate and fiberglass, or a combination of these materials.

Slides useful in the device or viewer may be standard microscope slides with one, two or no depressions onto which the DNA specimen may be fixed and preserved. A two sections device or viewer may comprises means for securing the slide to the slide receptacle. For example the surface of the slide receptacle on which the slide is disposed may comprise threaded openings to which a slide having openings at each end thereof through which a screw may be inserted is threadably secured.

Particularly, embodiments of the present invention are better illustrated with reference to the Figure(s), however, such reference is not meant to limit the present invention in any fashion. The embodiments and variations described in detail herein are to be interpreted by the appended claims and equivalents thereof.

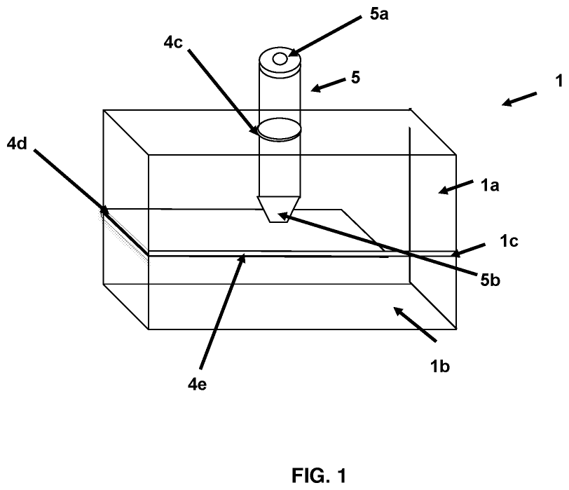

FIG. 1 shows a device for viewing a DNA specimen on a slide. The device comprises an optically transparent rectangular cuboidal body 1 with a top portion or top viewing portion 1a, a bottom portion or bottom base portion 1b which meet at an interface 1c. The body comprises an opening 4c formed through a top surface of the top viewing portion through to the interface, a viewing scope 5 disposed within the opening, a slide receptacle 4d formed from a slot 4e in the bottom base portion at the interface. The viewing scope 5 comprises an eye piece 5a at a proximal end and a magnifying lens 5b at a distal end.

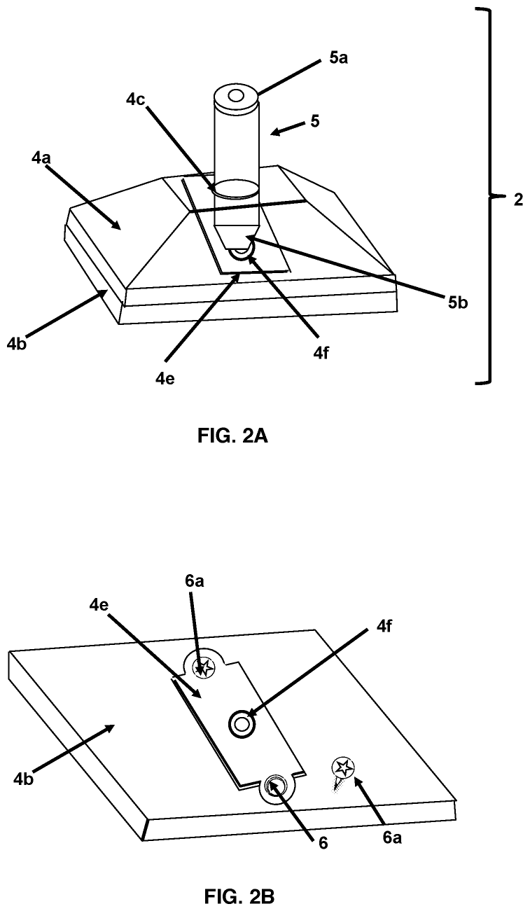

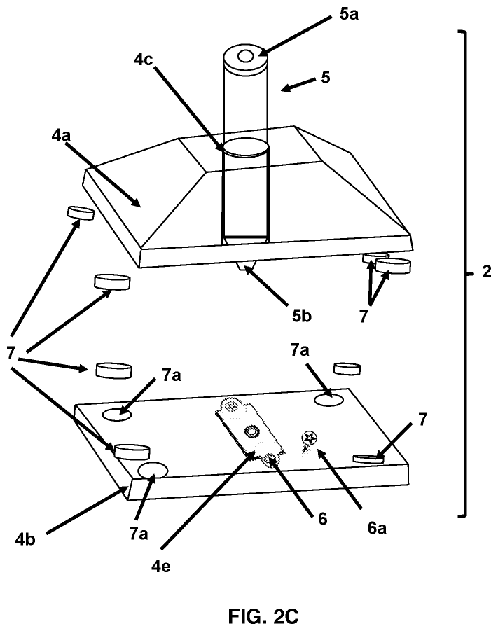

FIG. 2A is a shows a device for viewing a DNA specimen. This device 2 comprises an optically transparent top section or top viewing section 4a with an opening 4c formed through the top surface thereof, a transparent bottom section or bottom base section 4b, a viewing scope 5 comprising an eye piece 5a, a magnifying lens 5b and a slide receptacle 4e formed on the top surface of the bottom base section. An opening 4f formed through the bottom base section to the slide receptacle enables ambient light to reach the viewing scope.

With continued reference to FIG. 2A, FIG. 2B illustrates the top surface of the bottom section 4b showing the slide receptacle 4e with a slide with fixed DNA sample disposed therein. The slide receptacle comprises a pair of threaded openings 6 for securing a slide with a fixed specimen with screws 6a.

With continued reference to FIGS. 2A and 2B, FIG. 2C is an exploded view of the device 2 showing the fully transparent top viewing section 4a, transparent bottom base section 4b, viewing scope 5, slide receptacle 4e and a plurality of magnets 7 inset within a plurality of cavities 7a formed on a top surface of the bottom section and a bottom surface of the top section. The magnets enable connection of the top viewing section to the bottom base section.

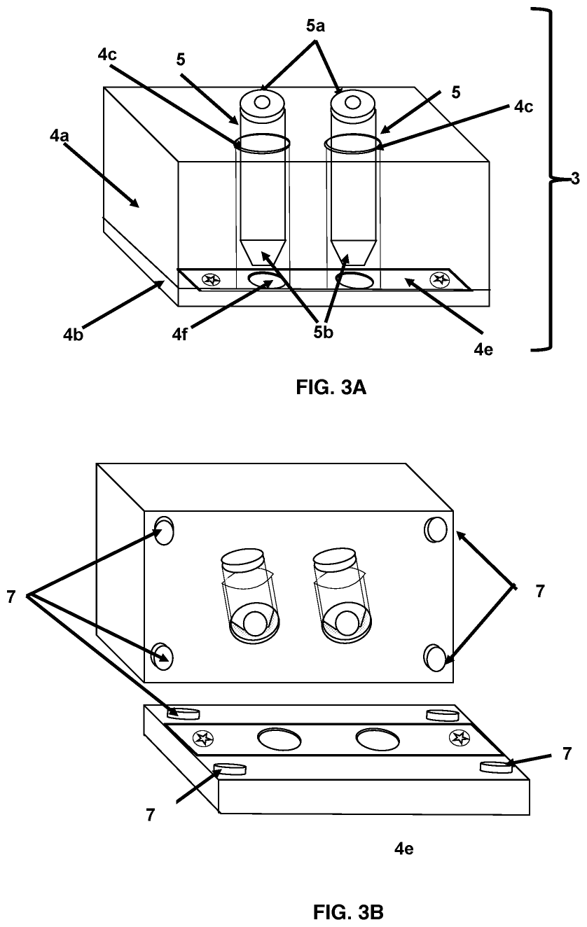

With continued reference to FIG. 2A, FIG. 3A is a front view illustrating a device 3 for viewing more than one DNA specimen. The devices comprises the fully transparent rectangular cuboidal top viewing section 4a, a transparent bottom base section 4b, a pair of the openings 4c formed on through the top surface of the top viewing section, a pair 5 of viewing scopes each comprising the eye piece 5a and the magnifying lens 5b and a slide receptacle 4e. The slide receptacle comprises a pair of the openings 4f through the bottom base section to enable transmission of ambient light.

With continued reference to FIG. 2C and FIG. 3A, FIG. 3B is an open view of the device 3 showing the magnetically connected top viewing section disengaged from the magnets 7 in the bottom base section

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below.

What is claimed is:

1. A device for storing and viewing a preserved DNA specimen, comprising:
a top viewing section with a top surface and a bottom surface and at least one opening formed through the top surface to the bottom surface;
a bottom base section with a top base surface and a bottom base surface, said top base surface removably connectable with the bottom surface of the top viewing section;
at least one slide receptacle formed on the top base surface and sized to receive therein a slide on which the DNA specimen is preserved;
at least one viewing scope comprising an eyepiece at a proximal end thereof and a magnifying lens at a distal end thereof, said viewing scope disposed within the at least one opening through the top viewing section in optical alignment with the opening formed through the slide receptacle; and
means for connecting the top viewing section to the bottom base section.

2. The device of claim 1, further comprising a slot formed on an outer surface of the bottom base section in connection with the slide receptacle.

3. The device of claim 1, further comprising at least one opening formed through the bottom base surface of the bottom base section to the slide receptacle and in optical alignment with the viewing scope.

4. The device of claim 1, wherein the slide receptacle is sized with dimensions larger than dimensions of the slide such that the slide is movable therewithin to optically align the DNA specimen with the viewing scope.

5. The device of claim 1, further comprising means for securing the slide to the slide receptacle.

6. The device of claim 1, wherein the means for connecting the top viewing section to the bottom base section is a plurality of magnets disposed on the bottom surface of the top viewing section and on the top base surface of the bottom base section.

7. The device of claim 6, wherein the bottom surface of the top viewing section and the top base surface of the bottom base section each further comprise a plurality of cavities formed thereon, said bottom surface cavities in alignment with the top base surface cavities and said plurality of magnets disposed within the cavities.

8. The device of claim 1, wherein the top viewing section is substantially transparent.

9. The device of claim 1, wherein the top viewing section is substantially cuboid in shape or substantially pyramidal in shape.

10. The device of claim 1, wherein the bottom base section of the viewer is substantially cuboid.

11. The device of claim 1, wherein the top viewing section and the bottom base section are independently made from at least one material selected from the group consisting of a plastic, a plastic composite, a metal, and a metal composite.

12. The device of claim 11, wherein the plastic is selected from the group consisting of polyethylene terephthalate, polyethylene, polyvinyl chloride, polypropylene, polystyrene, polycarbonate, poly(methyl methacrylate) and fiberglass.

13. The device of claim 1, wherein the preserved DNA specimen is a preimplantation embryonic DNA specimen or a eukaryotic cellular DNA specimen.

14. A viewer for viewing a preserved DNA specimen comprising:
an optically transparent and substantially solid body comprising:
an upper viewing portion interfaced with a lower base portion;
an opening formed on the upper viewing portion through to the interface with the lower base portion;
a slot formed on an outer surface of the body at the interface; and
a slide receptacle formed from the slot at the interface and with dimensions sufficient to receive through the slot a slide on which the DNA specimen is preserved; and
a viewing scope comprising an eyepiece at a proximal end thereof and a magnifying lens at a distal end thereof disposed within the opening in the upper viewing portion and in optical alignment with the slide receptacle.

15. The viewer of claim 14, further comprising an opening formed on the lower base portion through to the slide receptacle and in optical alignment with the opening through the upper viewing portion.

16. The viewer of claim 14, wherein the dimensions of the slide receptacle are larger than dimensions of the slide such that the slide is movable therewithin to optically align the DNA specimen thereon with the viewing scope.

17. The viewer of claim 14, wherein the body is substantially cuboid or substantially pyramidal in shape.

18. The viewer of claim 14, wherein the body is made from a plastic material or a plastic composite material.

19. The viewer of claim 17, wherein the plastic material is selected from the group consisting of polyethylene terephthalate, polyethylene, polyvinyl chloride, polypropylene, polystyrene, polycarbonate, poly(methyl methacrylate) and fiberglass.

20. The viewer of claim 14, wherein the preserved DNA specimen is a preimplantation embryonic DNA specimen or a eukaryotic cellular DNA specimen.
